(19) United States
(12) Patent Application Publication
(10) Pub. No.: US 2007/0091081 A1
(43) Pub. Date: Apr. 26, 2007

(54) Electronic sign with flexible display films

(76) Inventor: Christopher Sibley, Nanaimo (CA)

Correspondence Address: DAVIS & BUJOLD, P.L.L.C., 112 PLEASANT STREET, CONCORD, NH, 03301, US

(21) Appl. No.: 11/541,628

(22) Filed: Sep. 29, 2006

(30) Foreign Application Priority Data
Oct. 7, 2005 (CA) 2,522,344

(51) Int. Cl. G09G 5/00

(52) U.S. Cl. 345/204

(57) ABSTRACT

An electronic sign includes a support structure having at least one display mounting surface. A display film of light emitting material containing a matrix of pixels is mounted on each display mounting surface of the support structure. An interface is provided which is adapted for downloading a message to be displayed on the display film.

This application claims priority from Canadian Application Serial No. 2,522,344 filed Oct. 7, 2005.

### FIELD OF THE INVENTION

The present invention relates to an electronic sign with flexible display films.

### BACKGROUND OF THE INVENTION

U.S. Pat. No. 6,101,750 (Blesener et al 2000) is an example of an electronic sign that is gradually displacing other forms of signage.

### SUMMARY OF THE INVENTION

According to the present invention there is provided an electronic sign which includes a support structure having at least one display mounting surface. A display film of light emitting material containing a matrix of pixels is mounted on each display mounting surface of the support structure. An interface is provided which is adapted for downloading a message to be displayed on the display film.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is an exploded top plan view of an electronic sign constructed in accordance with the teachings of the present invention.

FIG. 2 is a side elevation view of the electronic sign illustrated in FIG. 1, with one of the side display panels removed.

FIG. 3 is a bottom plan view of the electronic sign illustrated in FIG. 1.

FIG. 4 is a rear elevation view of the electronic sign illustrated in FIG. 1.

### DETAILED DESCRIPTION OF THE PREFERRED EMBODIMENT

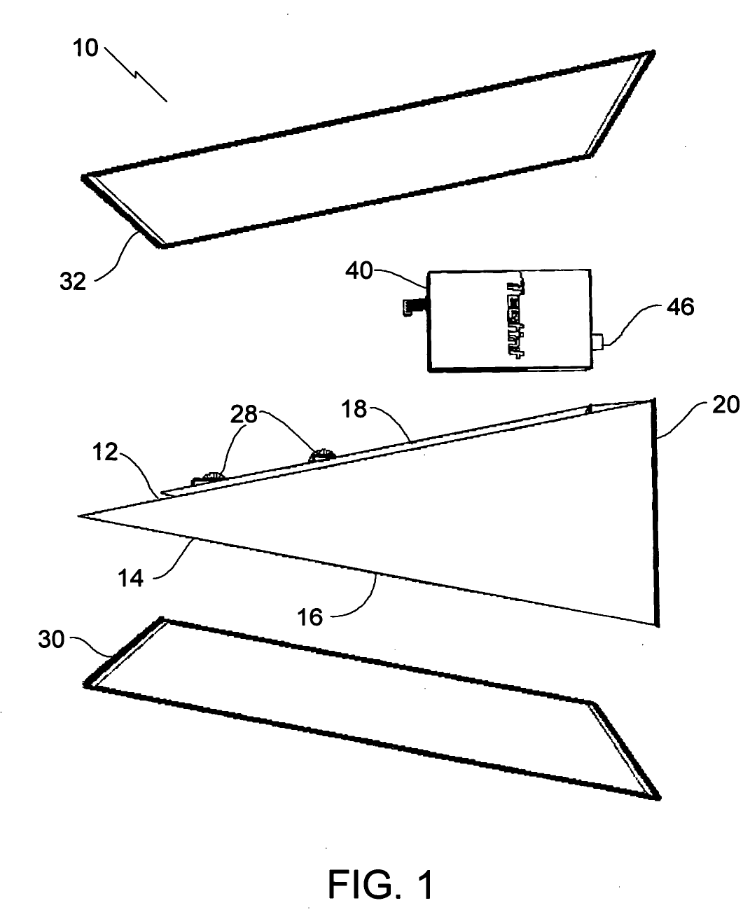

The preferred embodiment, an electronic sign generally identified by reference numeral 10, will now be described with reference to FIG. 1 through 4.

Structure and Relationship of Parts:

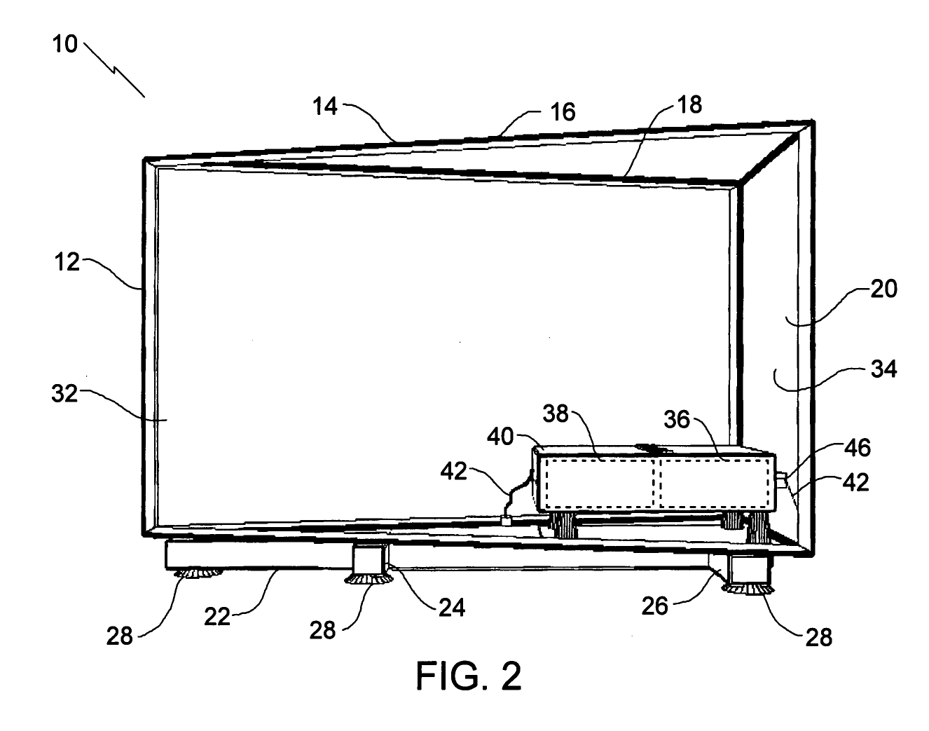

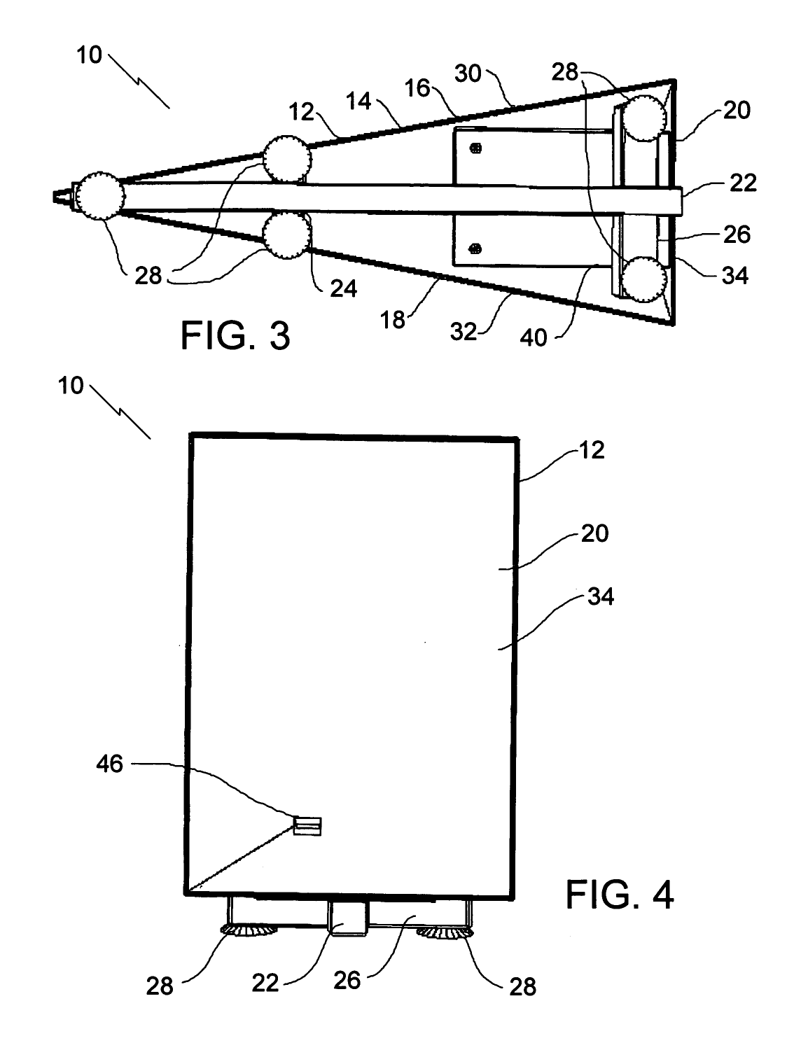

Referring to FIG. 2, electronic sign 10 has a support structure 12 in the form of a wedge shaped frame 14. Referring to FIG. 3, wedge shaped frame 14 is capable of providing a maximum of thee mounting surfaces on which a display film may be mounted, including a first side mounting surface 16, a second side mounting surface, 18, and a rear mounting surface 20. Wedge shaped frame 14 has an underlying support beam 22 with transverse cross-members 24 and 26. This embodiment of electronic sign 10 was developed for a pizza chain for use as roof top signage on their pizza delivery vehicles. It will be appreciated, that for different applications the support structure may have an entirely different appearance. In view of the intended application support beam 22 and cross-members 24 and 26 were equipped with underlying suction cups 28, adapted to adhere edge shaped frame 14 to a vehicle roof surface (not shown) by suction.

Referring to FIG. 1, a display film of light emitting material is placed on each mounting surface of wedge shaped frame 14. A first display film 30 is placed on first side mounting surface 16 and a second display film 32 is placed on second side mounting surface 18. Referring to FIG. 4, a third display film 34 may optionally be placed on rear mounting surface 20. It will appreciated that beneficial results may be obtained through use of just first display film 30 and the second display film 32. It is preferred that display film be one of an organic light emitting diode or a flexible liquid crystal display. The display film contains a matrix of pixels. It is preferred that the matrix of pixels be an active matrix in which each pixel remains static in either an “on” or “off” condition.

Referring to FIG. 2, a controller 36 is provided having a memory in which is stored graphic images, alpha-numeric characters or a combination of the same conveying the message to be displayed. A power source 38 is provided within the same housing 40 that houses controller 36. A conductive circuit 42 is provided that connects first display film 30, second display film 32, third display film 34, controller 36 and power source 40. Graphic images and alpha-numeric characters stored in controller 36 are displayed on display films 30, 32, and 34 by providing power from power source 40 to illuminate selected pixels of the matrix of pixels. Power from power source 40 need only be provided temporarily, as the active matrix of display films 30, 32, and 34 will continue to display the message provided by controller 36 even after power is no longer provided from power source 40. Referring to FIG. 4, an interface 46 is provided which is adapted for downloading a message to be displayed to controller 36. The interface can take a number of forms, such as a USB port or a disk drive.

The pizza delivery chain expressed interest in electronic sign 10 due to the ease with which the message could be changed. This enables the pizza delivery chain to change the message daily to feature daily specials. They can also change the message during the course of the day to feature lunch, supper and late evening specials.

The active matrix is the display permits the message to be changed and then power removed. Even after power is removed, the active matrix will continue to display the last image. However, there is no reason why the image displayed must be a static image, if one is prepared to provide power continuously to the display film. In such an installation, the message provided by controller 36 can be a dynamically changing sequence of graphic images, alpha-numeric characters or combination of the same.

Operation:

Referring to FIG. 2, wedge shaped frame 14 is secured to a roof of a vehicle by with suction cups 28. In order to make the installation more aerodynamic it is preferred that the narrow end of wedge shaped frame 14 be oriented toward the front of the vehicle. It can, of course, also function with the narrow end of wedge shaped frame 14 oriented toward the rear of the vehicle. Power is provided from power source 38 is temporarily provided to activate controller 36. The message to be displayed is introduced to controller 36 via interface 42. The message is then displayed on first display film 30, second display film 32, and third display film 34. Power is then turned off. However, because display films 30, 32, and 34 are active matrix display films, active matrix will continue to display the message.

Where a dynamic message is desired, continuous power will have to be provided. A dynamic message will be stored in controller 36, resulting in a dynamically changing sequence of images being displayed.

Advantages:

The electronic signage, as described above, provide a number of distinct advantages:
a. An active matrix can be used in which each pixel remains static in either an “on” or “off” condition. This means that the interface need only provide a temporary connection to a controller having a memory in which the message is stored and the power source providing power to illuminate selected pixels in the matrix of pixels, as the display film continues to display the message provided by the controller even when power is no longer provided from the power source;
b. The message provided by the controller can be a dynamically changing sequence of graphic images, alpha-numeric characters or combination of the same; and
c. The display mounting surface can be made non-planar, as a flexible display film can be made to conform to the non-planar topography of the non-planar display mounting surface.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. An electronic sign, comprising:
a support structure having at least one display mounting surface;
a display film of light emitting material containing a matrix of pixels mounted on each display mounting surface of the support structure; and
an interface adapted for downloading a message to be displayed on the display film.

2. The electronic sign as defined in claim 1, wherein the interface provides a continuous connection to:
a controller having a memory in which is stored graphic images, alpha-numeric characters or a combination of the same conveying the message;
a power source; and
a conductive circuit connecting the display film, the controller and the power source, whereby the graphic images and alpha-numeric characters stored in the controller are displayed on the display film by providing power from the power source to illuminate selected pixels of the matrix of pixels.

3. The electronic sign as defined in claim 2, wherein the message provided by the controller is a dynamically changing sequence of graphic images, alpha-numeric characters or combination of the same.

4. The electronic sign as defined in claim 1, wherein the display film is one of an organic light emitting diode or a flexible liquid crystal display.

5. The electronic sign as defined in claim 2, wherein the matrix of pixels is an active matrix in which each pixel remains static in either an “on” or “off” condition, and the interface provides a temporary connection to a controller having a memory in which is stored at least one graphic or alpha-numeric message and a power source providing power to illuminate selected pixels in the matrix of pixels, with the display film continuing to display the message provided by the controller even when power is no longer provided from the power source.

6. The electronic sign as defined in claim 1, wherein the support structure is a frame.

7. The electronic sign as defined in claim 6, wherein the frame is a wedge shape.

8. The electronic sign as defined in claim 6, wherein the frame has at least one underlying support beam with transverse cross-members.

9. The electronic sign as defined in claim 6, wherein the frame has underlying suction cups, adapted to adhere the frame to a surface by suction.

10. An electronic sign, comprising:
a support structure having at least one display mounting surface;
a display film of light emitting material, the display film being one of an organic light emitting diode or a flexible liquid crystal display, the display film containing a matrix of pixels mounted on each display mounting surface of the support structure, the matrix of pixels being an active matrix in which each pixel remains static in either an “on” or “off” condition;
a controller having a memory in which is stored graphic images, alpha-numeric characters or a combination of the same conveying the message;
a power source;
a conductive circuit connecting the display film, the controller and the power source, whereby the graphic images and alpha-numeric characters stored in the controller are displayed on the display film by providing power from the power source to illuminate selected pixels of the matrix of pixels, the active matrix display film continuing to display the message provided by the controller even when power is no longer provided from the power source; and
an interface adapted for downloading a message to be displayed on the display film to the controller.

11. The electronic sign as defined in claim 10, wherein the message provided by the controller is a dynamically changing sequence of graphic images, alpha-numeric characters or combination of the same.

12. An electronic sign, comprising:
a support structure in the form of a wedge shaped frame providing at least two display mounting surface, the support structure including an underlying support beam with transverse cross-members;
a display film of light emitting material, the display film being one of an organic light emitting diode or a flexible liquid crystal display, the display film containing a matrix of pixels mounted on each display mounting surface of the support structure, the matrix of pixels being an active matrix in which each pixel remains static in either an “on” or “off” condition;
a controller having a memory in which is stored graphic images, alpha-numeric characters or a combination of the same conveying the message;
a power source;
a conductive circuit connecting the display film, the controller and the power source, whereby the graphic images and alpha-numeric characters stored in the controller are displayed on the display film by providing power from the power source to illuminate selected pixels of the matrix of pixels, the active matrix display film continuing to display the message provided by the controller even when power is no longer provided from the power source; and
an interface adapted for downloading a message to be displayed on the display film to the controller.

13. The electronic sign as defined in claim 12, wherein the message provided by the controller is a dynamically changing sequence of graphic images, alpha-numeric characters or combination of the same.

14. The electronic sign as defined in claim 12, wherein the support beam and cross-members have underlying suction cups, adapted to adhere the frame to a surface by suction.
